(19) United States
(12) Patent Application Publication
(10) Pub. No.: US 2026/0369030 A1
(43) Pub. Date: Nov. 19, 2026

(54) INFORMATION PROCESSING DEVICE AND INFORMATION PROCESSING METHOD

(71) Applicant: Sony Semiconductor Solutions Corporation, Kanagawa (JP)

(72) Inventor: Yukinao KENJO, Basingstoke (GB)

(73) Assignee: Sony Semiconductor Solutions Corporation, Kanagawa (JP)

(21) Appl. No.: 19/477,803

(22) PCT Filed: Jun. 27, 2024
(86) PCT No.: PCT/EP2024/068138

§ 371 Date: Oct. 23, 2025

(30) Foreign Application Priority Data
Jun. 29, 2023 (EP) 23182408.7

(51) Int. Cl. G06V 10/75; G01S 17/86; G01S 17/894; G06T 7/13

(52) U.S. Cl. CPC G06V 10/751; G01S 17/86; G01S 17/894; G06T 7/13; G06V 2201/07

(57) ABSTRACT

An information processing device for correcting spot misalignment in a fusion of image data and spot time-of-flight data, including circuitry configured to: detect, based on obtained image data, an edge of a foreground object and a background; detect spots in obtained spot time-of-flight data; associate the spots with the image data; detect, among the spots, edge spots which are within a predetermined distance to the edge; and determine, for each edge spot, a difference between a characteristic of the respective edge spot and a corresponding characteristic of at least one adjacent spot for estimating whether the respective edge spot is misaligned.

### TECHNICAL FIELD

The present disclosure generally pertains to an information processing device and an information processing method for correcting spot misalignment in a fusion of image data and spot time-of-flight data.

### TECHNICAL BACKGROUND

Generally, imaging devices are known which acquire image data representing a captured (color) image of a scene.

Additionally, time-of-flight (“ToF”) devices are known which acquire ToF data and determine a depth map of a scene based on a ToF of light that is emitted by an illuminator of the ToF device, thrown back by an object in the scene and detected by a ToF sensor of the ToF device, wherein the ToF of the light is determined based on the round-trip time (direct ToF device) or the phase of the detected light (indirect ToF device).

Moreover, spot ToF devices are known in which the illuminator emits spotted light to the scene, for example, a light pattern of separated high-intensity and low-intensity light areas such as a pattern of light dots.

Some applications, for example, some augmented reality (“AR”) applications require sensing data from more than one sensing device, e.g., from an imaging device and a ToF device to obtain accurate information about the environment and the scene. The different sensing data may be fused to improve the information about the scene for enhanced performance and accuracy of AR applications. The disclosure may also be applicable to mixed reality applications (“MR”), for example, where physical and digital elements can interact. Moreover, the disclosure may also be applicable to virtual reality applications (“VR”).

However, there may occur, in some cases, a mismatch between information extracted from the individual sensing data which may lead to artefacts and may reduce the benefit of combining both sensing data.

Although there exist techniques for fusing image data and spot ToF data, it is generally desirable to improve the existing techniques.

### SUMMARY

According to a first aspect, the disclosure provides an information processing device for correcting spot misalignment in a fusion of image data and spot time-of-flight data, comprising circuitry configured to:
detect, based on obtained image data, an edge of a foreground object and a background;
detect spots in obtained spot time-of-flight data;
associate the spots with the image data;
detect, among the spots, edge spots which are within a predetermined distance to the edge; and
determine, for each edge spot, a difference between a characteristic of the respective edge spot and a corresponding characteristic of at least one adjacent spot for estimating whether the respective edge spot is misaligned.

According to a second aspect, the disclosure provides an information processing method for correcting spot misalignment in a fusion of image data and spot time-of-flight data, comprising:
detecting, based on obtained image data, an edge of a foreground object and a background;
detecting spots in obtained spot time-of-flight data;
associating the spots with the image data;
detecting, among the spots, edge spots which are within a predetermined distance to the edge; and
determining, for each edge spot, a difference between a characteristic of the respective edge spot and a corresponding characteristic of at least one adjacent spot for estimating whether the respective edge spot is misaligned.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 schematically illustrates in a block diagram an embodiment of an information processing device;

FIG. 2 schematically illustrates an embodiment of edge detection;

FIG. 3 schematically illustrates an embodiment of spot detection;

FIG. 4 schematically illustrates in a flow diagram an embodiment of an information processing method for correcting spot misalignment;

FIG. 5 schematically illustrates in a flow diagram an embodiment of a spot misalignment filter;

FIG. 6 schematically illustrates an embodiment of determining a spatial weight kernel;

FIG. 7 schematically illustrates an embodiment of determining a guide image weight kernel;

FIG. 8 schematically illustrates an embodiment of determining a depth weight kernel;

FIG. 9 schematically illustrates an embodiment of RGB-D fusion; and

FIG. 10 schematically illustrates in a flow diagram an embodiment of an information processing method for correcting spot misalignment.

### DETAILED DESCRIPTION OF EMBODIMENTS

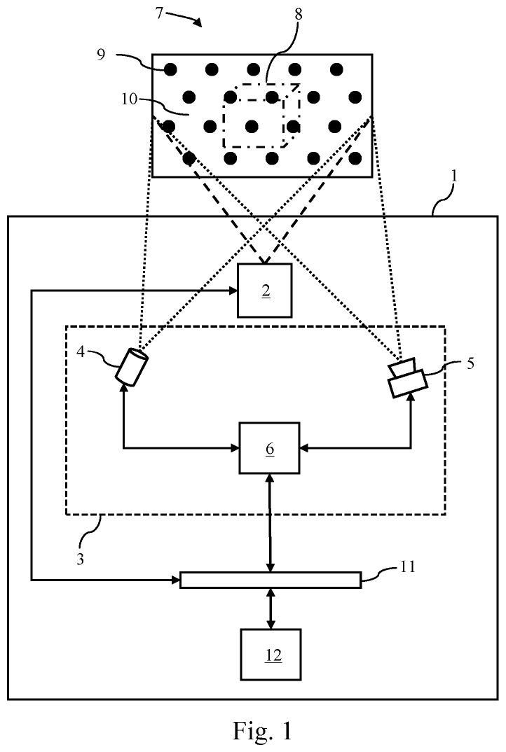

Before a detailed description of the embodiments under reference of FIG. 1 is given, general explanations are made.

As mentioned in the outset, some applications, for example, some augmented reality (“AR”) applications require sensing data from more than one sensing device, e.g., from an imaging device and a time-of-flight device to obtain accurate information about the environment and the scene. The different sensing data may be fused to improve the information about the scene for enhanced performance and accuracy of AR applications. The disclosure may also be applicable to mixed reality applications (“MR”), for example, where physical and digital elements can interact. Moreover, the disclosure may also be applicable to virtual reality applications (“VR”).

However, there may occur, in some cases, a mismatch between information extracted from the individual sensing data which may lead to artefacts and may reduce the benefit of combining both sensing data.

It has been recognized that the artefacts occur in particular at the edge of an object in front of a background or other objects.

Hence, some embodiments pertain to an information processing device for correcting spot misalignment in a fusion of image data and spot time-of-flight data, wherein the information processing device includes circuitry configured to:
detect, based on obtained image data, an edge of a foreground object and a background;
detect spots in obtained spot time-of-flight data;
associate the spots with the image data;
detect, among the spots, edge spots which are within a predetermined distance to the edge; and
determine, for each edge spot, a difference between a characteristic of the respective edge spot and a corresponding characteristic of at least one adjacent spot for estimating whether the respective edge spot is misaligned.

The information processing device may be a data processing module, a computer, a server, a mobile terminal (such as a smartphone, a tablet, a laptop, etc.), a virtual reality device or the like. Further examples include a head mounted display or headset with on board processing or a head mounted display or headset where at least some computations for the display are made on a computing device connected by wire or wireless communications. In some embodiments, the computing device may be a gaming console.

Thus, in some embodiments, the information processing device is a mobile terminal.

The circuitry may be based on or may include or may be implemented as integrated circuitry logic or may be implemented by a central processing unit (“CPU”), an application processor, a graphical processing unit (“GPU”), a digital signal processor, a microcontroller, a field programmable gate array (“FPGA”), an application specific integrated circuit (“ASIC”) or the like, or a combination thereof.

The functionality may be implemented by software executed by a processor such as a microprocessor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include data storage capabilities to store data such as memory which may be based on semiconductor storage technology (e.g., RAM, EPROM, etc.) or magnetic storage technology (e.g., a hard disk drive) or the like.

The circuitry may include a data bus for receiving and transmitting data over the data bus. The circuitry may implement communication protocols for receiving and transmitting the data over the data bus.

In some embodiments, the information processing device includes an imaging device to obtain the image data.

The imaging device may be a camera module or a camera or the like configured to obtain image data. The imaging device may include optical parts (e.g., lenses, color filters, etc.), a controller, a data bus interface, an image sensor (e.g., a charge-coupled device (“CCD”) sensor or an active pixel sensor such as a CMOS (“Complementary Metal-Oxide-Semiconductor”) sensor), and the like. The image sensor may include an image pixel array including a plurality of image pixels (e.g., CCD pixel or active pixel such as a CMOS pixel) arranged in rows and columns.

The image data may thus include a plurality of image pixel positions (e.g., the row and column index of each image pixel in the image pixel array) and one or more color values (e.g., red-green-blue (“RGB”) color values) for each image pixel position, which may be represented as an array, as generally known.

In some embodiments, the image data are RGB image data. In such embodiments, the image sensor is configured to detect visible light.

In some embodiments, the information processing device includes a spot time-of-flight device to obtain the spot time-of-flight data.

In some embodiments, the spot time-of-flight device is a spot indirect time-of-flight device.

The spot (indirect) time-of-flight device may include a spot illuminator configured to illuminate a scene with spotted light.

The spot illuminator may include a light source such as light emitting diode (“LED”), a laser, a laser diode, an LED array, a laser diode array, and may include a diffractive optical element, a lens system, and the like.

The spotted light may have a spatial light pattern including high-intensity light areas and low-intensity light areas and, thus, a plurality of light spots corresponding to the high-intensity light areas is projected onto the scene. The light spots may be dots, stripes, a checker pattern or the like.

The spotted light is further temporal intensity modulated with a configured modulation frequency in accordance with an applied modulation signal. The applied modulation signal is a periodic signal which may be a sinusoidal signal, a rectangular signal, or the like.

The spot (indirect) time-of-flight device may include a time-of-flight sensor configured to detect light thrown back by an object in a scene.

The time-of-flight sensor may include a time-of-flight pixel array including plurality of time-of-flight pixels arranged in rows and columns, wherein each time-of-flight pixel may be a current assisted photonic demodulator (“CAPD”) pixel array including a plurality of CAPD pixels (e.g., one-tapped, two-tapped, etc.) arranged in rows and columns.

The time-of-flight sensor may be embedded in a time-of-flight camera module or time-of-flight camera which may further include optical elements such as a (n) (adaptive) lens system, color filters, a diffractive optical element, and the like.

The spot (indirect) time-of-flight device may include a controller configured to control the overall operation of the spot (indirect) time-of-flight device.

In some embodiments, a spot indirect time-of-flight measurement, which is performed by a spot indirect time-of-flight device, may include four correlation measurements, wherein for each correlation measurement a different phase shift between a modulation signal applied to the spot illuminator and a demodulation signal applied to the time-of-flight sensor is utilized (e.g., 0°, 90°, 180° and) 270°, wherein the modulation signal and the demodulation signal are synchronized.

In some embodiments, for each correlation measurement, the controller outputs one frame, wherein the frame includes digital representations of the output voltages of each CAPD pixel.

In some embodiments, the controller performs pre-processing by computing IQ values (I: in-phase component; Q: quadrature component) for each CAPD pixel, wherein the IQ values are based on the frames of the correlation measurements, thereby computing one frame with IQ values for each CAPD pixel, which is output.

Thus, in some embodiments, the spot time-of-flight data include one or more frames including digital representations of output voltages or IQ values.

In some embodiments, the information processing device (the circuitry thereof) determines, based on the output voltages or IQ values, a depth value for each time-of-flight pixel position.

In some embodiments, the information processing device (the circuitry thereof) is further configured to perform direct and global separation (“DGS”), based on the spot time-of-flight data, to reduce the multipath contribution, as generally known.

The spot time-of-flight data may thus include a plurality of time-of-flight pixel positions (e.g., the row and column index of each time-of-flight pixel in the time-of-flight pixel array) and one or more output voltages or IQ values or a depth value for each time-of-flight pixel position.

In some embodiments, the spot time-of-flight data are infrared spot time-of-flight data. In such embodiments, the spot illuminator illuminates the scene with infrared light and the time-of-flight sensor is configured to detect infrared light.

As mentioned above, the information processing device (the circuitry thereof) detects, based on obtained image data, an edge of a foreground object and a background.

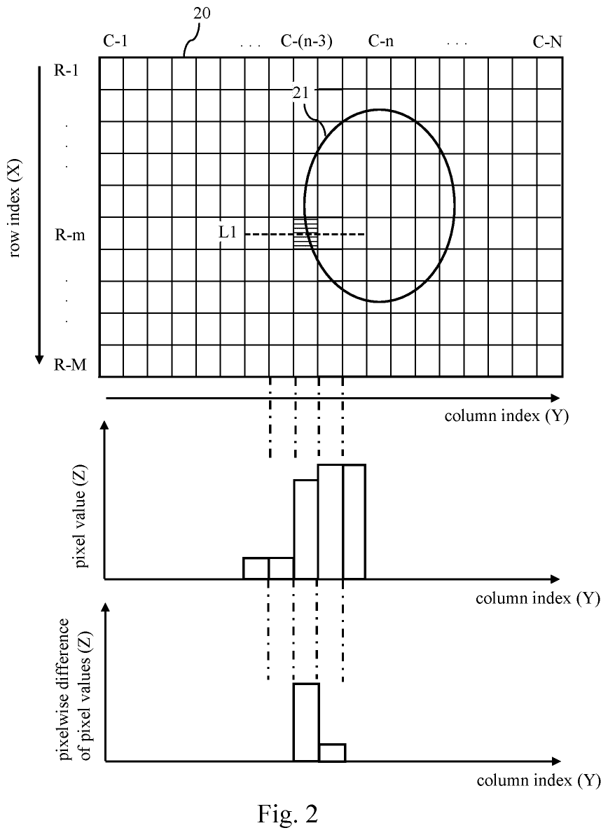

Generally, a variety of edge detection algorithms are known in image processing, for example, based on binary thresholding, Canny edge detection, etc. An embodiment will be discussed under reference of FIG. 2 further below.

The information processing device may thus store image pixel positions which are associated with an edge of an object (edge image pixel position). Moreover, the information processing device may store a plurality of image pixel positions and the respective color values (e.g., RGB values) for each object and for the background.

The information processing device (the circuitry thereof) detects spots in obtained spot time-of-flight data.

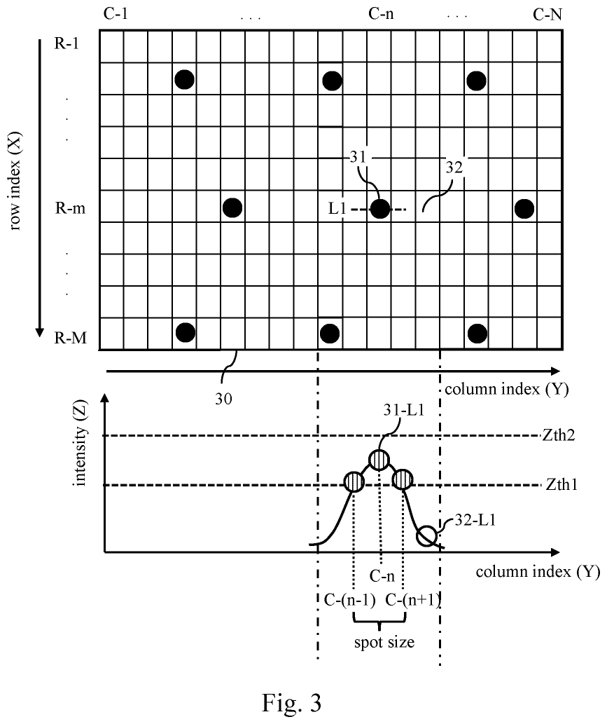

Generally, a variety of spot detection algorithms are known, wherein an embodiment for spot detection will be discussed under reference of FIG. 3 further below.

The information processing device may thus store a spot time-of-flight pixel position for each detected spot (e.g., the time-of-flight pixel position at which the spot has the maximum amplitude, intensity or confidence) and a depth value for the respective spot time-of-flight pixel position, wherein this data is referred to as spot data (not to be confused with spot ToF data).

The information processing device (the circuitry thereof) associates the spots with the image data.

The imaging device and the spot time-of-flight device may have a predetermined and calibrated orientation against each other such that each time-of-flight pixel position is associated with one image pixel position in accordance with the calibration and in accordance with the depth value of the detected spots due to the parallax between the imaging device and the spot time-of-flight device.

Hence, each spot time-of-flight pixel position is associated with one image pixel position (spot image pixel position).

The information processing device (the circuitry thereof) detects, among the spots, edge spots which are within a predetermined distance to the edge.

The predetermined distance may correspond to a number of one or more image pixels between an edge image pixel position and a spot image pixel position of a spot such that the spot is an edge spot (edge spot image pixel position).

The predetermined distance may be predetermined in the sense of preset or preconfigured in some embodiments. In some embodiments, the predetermined distance may additionally or alternatively be calculated on the fly, for example, using a predetermined algorithm. The predetermined distance may depend on a parameter of a spatial weight kernel (discussed further below) which may be adjustable.

The information processing device may thus store for each detected edge spot a spot time-of-flight pixel position (e.g., the time-of-flight pixel position at which the spot has the maximum intensity), an associated edge spot image pixel position (e.g., obtained through calibration and in accordance with the depth value of the respective detected spot due to the parallax between the imaging device and the spot time-of-flight device), a depth value for the spot time-of-flight pixel position and one or more color values associated with the edge spot image pixel position.

The information processing device (the circuitry thereof) determines, for each edge spot, a difference between a characteristic of the respective edge spot and a corresponding characteristic of at least one adjacent spot for estimating whether the respective edge spot is misaligned.

In some embodiments, the at least one adjacent spot belongs to the same (foreground) object as the respective edge spot. For illustration, if the edge spot is associated with the foreground object, the at least one adjacent spot may also be associated with the foreground object.

In some embodiments, the at least one adjacent spot includes a predetermined number of spots that have the shortest distance to the edge spot (distance between spot image pixel position and edge spot image pixel position, e.g., a number of image pixels).

As mentioned above, it has been recognized that the artefacts occur in particular at the edge of an object in front of a background or other objects.

Accordingly, it has been recognized that in particular for such edge spots it should be estimated whether the edge spot is misaligned.

Moreover, it has been recognized that an estimation may be based on a similarity of a characteristic of the edge spot and the neighboring spots.

It has been recognized that an estimation may be based on a similarity of a depth value of the edge spot and depth values of the neighboring spots, since, for example, a difference between them may indicate that they belong to different objects or to a foreground object and the background.

Hence, in some embodiments, the characteristic is a depth value.

Generally, the accuracy of the used edge detection algorithm may be limited, in some cases, such that an edge spot may have an edge spot image pixel position within a foreground object or the background with one or more associated color values that would actually correspond to the background or the foreground object, respectively.

It has thus been recognized that an estimation may be based on a similarity of a one or more color values at the edge spot image pixel position or a color distribution around the edge spot image pixel position and one or more color values at a spot image pixel position or a color distribution around the spot image pixel position of a neighboring/adjacent spot, respectively, since, for example, a difference between them may indicate that the edge spot actually belongs to the background or the foreground object, respectively.

Hence, in some embodiments, the characteristic is one or more color values.

Generally, the characteristic may be any value obtainable based on at least one of the spot time-of-flight data and the image data.

The characteristic may include, for example, a depth gradient and a color value gradient, or a combination thereof.

The characteristic may be a spatial characteristic, for example, a shape of the detected spot, wherein the shape of the spot corresponds to its size in various directions of the time-of-flight sensor plane, for example, the spot may be a circle in the time-of-flight sensor plane or an ellipse or an asymmetric spot. For illustration, a spot which results from a reflection at an edge of a spot may appear asymmetric or distorted or smaller than other spots with a similar depth value, since, e.g., a part of the illumination light is not reflected or scattered. This may indicate that the spot must be a spot which is close to the edge.

Whether the respective edge spot is estimated to be misaligned may be determined based on a first predetermined threshold. For example, in some embodiments, a difference below the first predetermined threshold may indicate that the edge spot is not misaligned and a difference above the first predetermined threshold may indicate that the edge spot is misaligned.

In some embodiments, the circuitry is further configured to associate an edge spot with a different image pixel position or to remove the edge spot, based on the determined difference.

In other words, when it is estimated that the edge spot is misaligned, in some embodiments, the edge spot may be moved to a different spot time-of-flight pixel position-which is equivalent to moving the edge spot to a different image pixel position when the spot time-of-flight data are associated with the image data.

The sign of the determined difference may indicate a direction for the movement and the amount of the determined difference may indicate an amount for the movement.

The movement may be predetermined and independent of the amount of the determined difference.

When, in some embodiments, more than one adjacent spot is considered, the determined differences may be, for example, averaged or summed up and the averaged or summed up determined difference is taken for determining the movement of the edge spot.

The edge spot may be removed, in some embodiments, when the determined difference exceeds a second predetermined threshold larger than the first predetermined threshold mentioned above.

The respective edge spot may be discarded or ignored or tagged to indicate that it should be ignored for the removal.

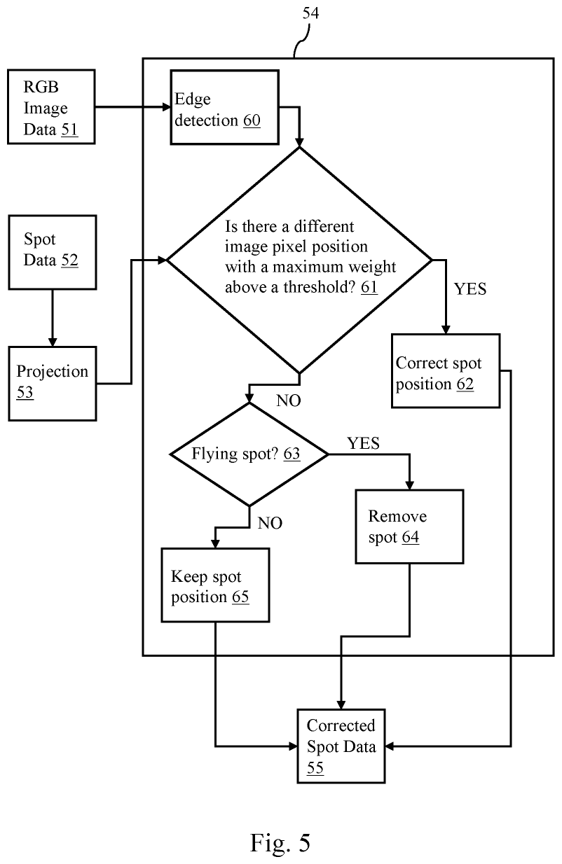

In some embodiments, the circuitry is further configured to determine, based on the determined difference, a weight kernel for estimating whether the respective edge spot is misaligned. Such embodiments will be discussed in more detail under reference of FIGS. 5 to 8.

In some embodiments, the weight kernel is further based on at least one of a guide image pixel weight kernel and a spatial weight kernel. Such embodiments will be discussed in more detail under reference of FIGS. 5 to 8.

In some embodiments, the circuitry is further configured to associate each edge spot with an image pixel position for which an associated weight of the weight kernel is maximal. Such embodiments will be discussed in more detail under reference of FIGS. 5 to 8.

In some embodiments, the circuitry is further configured to remove an edge spot when the corresponding weight kernel is below a preset threshold. Such embodiments will be discussed in more detail under reference of FIGS. 5 to 8.

In such embodiments, the edge spot is removed when a maximum of the weight kernel (correction score) is below the preset threshold. When an edge spot has many adjacent spots and the correction score is small though, it may be likely that it is a flying spot. A flying spot may be a result of scattering and multiple reflections of the light on its way back from the object to the time-of-flight sensor.

Moreover, in some embodiments, it is checked additionally whether the number of adjacent spots used for determining the weight kernel is above a second preset threshold.

Some embodiments pertain to an information processing method for correcting spot misalignment in a fusion of image data and spot time-of-flight data, wherein the information processing method includes:
detecting, based on obtained image data, an edge of a foreground object and a background;
detecting spots in obtained spot time-of-flight data;
associating the spots with the image data;
detecting, among the spots, edge spots which are within a predetermined distance to the edge; and
determining, for each edge spot, a difference between a characteristic of the respective edge spot and a corresponding characteristic of at least one adjacent spot for estimating whether the respective edge spot is misaligned.

The information processing method may be performed by the information processing device as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is schematically illustrated in a block diagram an embodiment of an information processing device 1, which is discussed in the following under reference of FIG. 1.

The information processing device 1 is a mobile terminal (e.g., a smartphone) and includes an imaging device 2, a spot time-of-flight device 3 and a data storage and processing module 12, which are coupled to a data bus 11 (e.g., a data bus in accordance with Mobile Industry Processor Interface (“MIPI”) specifications).

The imaging device 2 is configured to capture a color image of a scene 7 to obtain image data representing the image.

The data storage and processing module 12 obtains the image data via the data bus 11, wherein the image data are RGB image data.

The spot time-of-flight device 3 is a spot indirect time-of-flight (“spot iToF” in the following) device configured to obtain ToF data of the scene.

The orientation of the imaging device 2 and the spot iToF device 3 against each other is fixed and calibrated.

The spot iToF device 3 includes a spot illuminator 4, a time-of-flight camera module 5 and a controller 6, wherein the controller 6 controls the overall operation of the spot iToF device 3, in particular, the ToF data acquisition by controlling that a ToF measurement is performed.

The spot illuminator 4 includes, e.g., a diode laser array as a light source, a diffractive optical element and a lens to illuminate the scene 7 with spotted light. The scene 7 includes a foreground object 8 which at least partially throws back the spotted light.

The spotted light has a spatial light pattern including high-intensity areas 9 and low-intensity areas 10 and, thus, a plurality of light spots corresponding to the high-intensity areas 9 is projected onto the scene 7. The light pattern may include, for example, dots.

Moreover, the spot illuminator 4 emits the temporal intensity modulated light with a configured modulation frequency, in accordance with an applied modulation signal from the controller 6, to the scene 7. The applied modulation signal is a periodic signal such as a sinusoidal signal, a rectangular signal or the like.

The ToF camera module 5 includes, e.g., a lens, an aperture and an ToF sensor (not shown) to detect light thrown back by the object 8 in the scene 7.

The ToF sensor includes a plurality of two-tapped current-assisted photonic demodulator (CAPD) pixels arranged in rows and columns. Each CAPD pixel generates, in accordance with an applied demodulation signal from the controller 6, an output voltage in accordance with the phase of the received light signal.

The demodulation signal is further phase-shifted by 180° between a first tap and a second tap of the two-tapped CAPD pixel and the difference of the voltage of the two taps is output to decrease an ambient light contribution, pixel offset, etc. to the output voltage. The applied demodulation signal is a period signal such as a sinusoidal signal, a rectangular signal or the like in accordance with the modulation signal.

The controller 6 controls the spot iToF device 3 to perform a ToF measurement to obtain spot ToF data, for example, the ToF measurement includes four correlation measurements, wherein for each correlation measurement a different phase shift between the modulation signal applied to the spot illuminator 4 and the demodulation signal applied to the ToF sensor is utilized (e.g., 0°, 90°, 180° and) 270°.

The data storage and processing module 12 obtains from the controller 6 via the data bus 11 for each correlation measurement a frame including digital representations of the output voltages of the plurality of CAPD pixels from the ToF sensor as the spot ToF data.

The data storage and processing module 12 computes and stores a depth value and an amplitude value and/or a confidence value and/or an intensity value for each CAPD pixel as follows:

$$I = {V}_{0 °} - {V}_{180 °} , \qquad ( 1 )$$

$$Q = {V}_{270 °} - {V}_{90 °} , \qquad ( 2 )$$

$$confidence = \vert I \vert + \vert Q \vert , \qquad ( 3 )$$

$$amplitude = \frac{1}{2} \cdot \sqrt{{I}^{2} + {Q}^{2}} , \qquad ( 4 )$$

$$intensity = {amplitude}^{2} , \qquad ( 5 )$$

$$phase = arctan ( \frac{Q}{I} ) , \qquad ( 6 )$$

$$range = \frac{{T}_{mod} \cdot c}{2} , \qquad ( 7 )$$

$$depth = \frac{1}{2} \cdot range \cdot phase . \qquad ( 8 )$$

Here, V_{0°} is the digital representation of the respective CAPD pixel output voltage for a phase shift of 0° between the modulation and demodulation signal, V_{90°} is the digital representation of the respective CAPD pixel output voltage for a phase shift of 90° between the modulation and demodulation signal, V_{180°} is the digital representation of the respective CAPD pixel output voltage for a phase shift of 180° between the modulation and demodulation signal, and V_{270°} is the digital representation of the respective CAPD pixel output voltage for a phase shift of 270° between the modulation and demodulation signal. The modulation period of the modulation and demodulation signal is denoted with T_{mod} and c is the speed of light.

The data storage and processing module 12 is further configured to perform edge detection, spot detection and spot misalignment correction in a fusion of the image data and the spot ToF data, as will be discussed in the following under reference of FIGS. 2 to 9.

FIG. 2 schematically illustrates an embodiment of edge detection, which will be discussed in the following.

An image sensor 20 (of the imaging device 2 in FIG. 1) is schematically illustrated in FIG. 2, which has a plurality of image pixels arranged in rows (R-1, . . . , R-m, . . . , R-M; wherein M is an Integer) and columns (C-1, . . . , C-n, . . . , C-N; wherein N is an Integer). Each image pixel has an image pixel position identified by its row index (X) and its column index (Y).

The data storage and processing module 12 obtains, as discussed above, image data representing an image of the scene 7, wherein the image data are acquired by the imaging device 2.

An edge 21 of a foreground object present in the scene 7 is schematically illustrated in FIG. 2.

The middle graph in FIG. 2 schematically depicts pixel values (Z) along the line L1, wherein the pixel value may be, for example, a color value or a grey value.

The pixel value is lower for the background and increases for the foreground object such that the edge 21 may be detected by determining whether a change of the pixel value from one image pixel to the adjacent image pixel exceeds a predetermined threshold.

As illustrated in the lower graph of FIG. 2, the pixelwise difference of the pixel values is large at the edge 21 such that the image pixel position X=R-m and Y=C-(n−3) is detected as an edge image pixel position.

FIG. 3 schematically illustrates an embodiment of spot detection, which is discussed in the following.

A ToF sensor 30 (of the ToF camera module 5 in FIG. 1) is schematically illustrated in FIG. 3, which has a plurality of two-tapped CAPD pixels arranged in rows (R-1, . . . , R-m, . . . , R-M; wherein M is an Integer) and columns (C-1, . . . , C-n, . . . , C-N; wherein N is an Integer). Each CAPD pixel has a ToF pixel position identified by its row index (X) and its column index (Y).

The data storage and processing module 12 obtains, as discussed above, spot ToF data acquired by the spot iToF device 3 in a ToF measurement from the controller 6.

The spot ToF data include a plurality of spots 31 and valleys 32 characterized, e.g., by the intensity values (Z) (see formula (5) above) associated with each ToF pixel position. The confidence values (see formula (3) above) and/or the amplitude values (see formula (4) above) may additionally or alternatively used.

The lower graph in FIG. 3 schematically depicts intensity values along the line L1 parallel to the row R-m in the vicinity of the column C-n.

As illustrated there, a spot may spread over one or more ToF pixels, e.g., centered at column C-n the spot is illustrated by reference number 31-L1—until the valley corresponding to the spot 32-L1-a valley ToF pixel of the valley is illustrated by reference number 32-L1.

The data storage and processing module 12 detects the spot 31-L1 based on a first predetermined intensity threshold Zth1. Furthermore, the data storage and processing module 12 may detect whether the spot 31-L1 is saturated based on a second predetermined intensity threshold Zth2.

Once the spot 31-L1 is detected, the data storage and processing module 12 associates the spot 31-L1 with a ToF pixel position, for example, with the ToF pixel position at which the spot 31-L1 has the maximal intensity value (Z), which is here for illustration: X=R-m and Y=C-n.

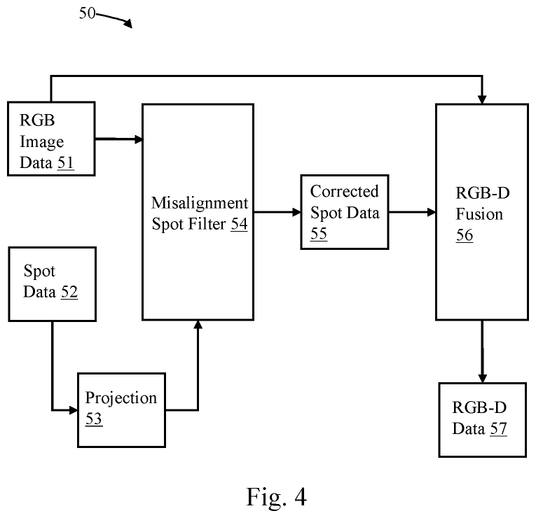

FIG. 4 schematically illustrates in a flow diagram an embodiment of an information processing method 50 for correcting spot misalignment, which is discussed in the following.

As mentioned above, the information processing method 50 is performed by the data storage and processing module 12 of FIG. 1.

At 51, RGB image data is input to a spot misalignment filter.

At 52, spot data are input to a projection routine, wherein the spot data includes detected spots which have been detected based on obtained spot ToF data.

At 53, the projection routine associates the detected spots with the RGB image data. This includes calculating the spot image pixel positions, based on the calibration and the depth values of the detected spots to account for the parallax between the imaging device 2 and the spot iToF device 3.

At 54, the projected spot data are input to the spot misalignment filter which performs edge detection and detects edge spots.

Moreover, at 54, the spot misalignment filter estimates whether an edge spot should be moved or even removed and performs the corresponding action.

Hence, at 55, corrected spot data is output.

The corrected spot data is fused, at 56, with the RGB image data which includes, for example, associating the corrected spot data with the RGB image data and interpolating the depth values over the entire RGB image data such that RGB-D data are obtained at 57.

An embodiment of the spot misalignment filter 54 is discussed in the following under reference of FIG. 5, which schematically illustrates in a flow diagram the embodiment.

At 60, the edge detection is performed in the image data.

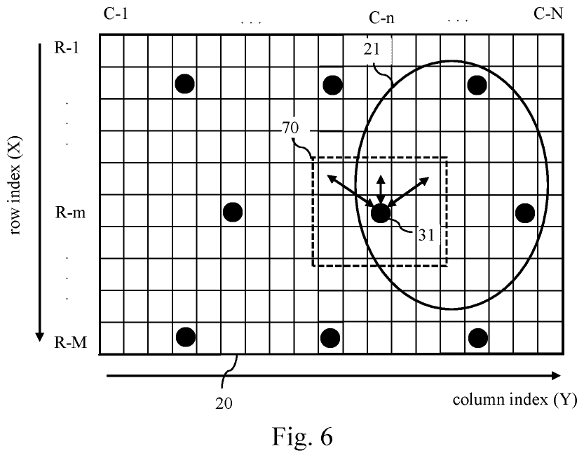

At 61, at first, edge spots are detected among the detected spots, based on the projected spot data. Then, further at 61, for each edge spot, a weight kernel is determined which will be discussed in the following under reference of FIGS. 6 to 8.

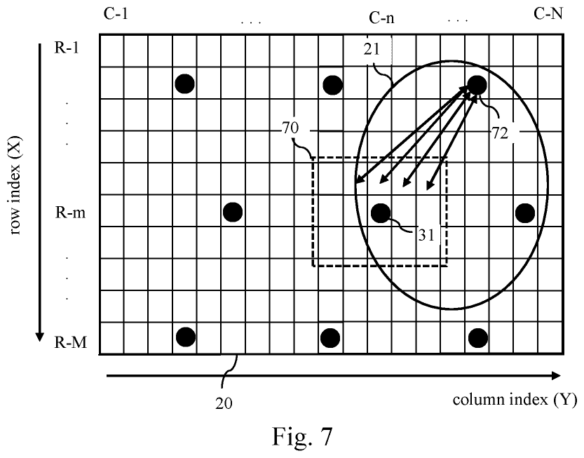

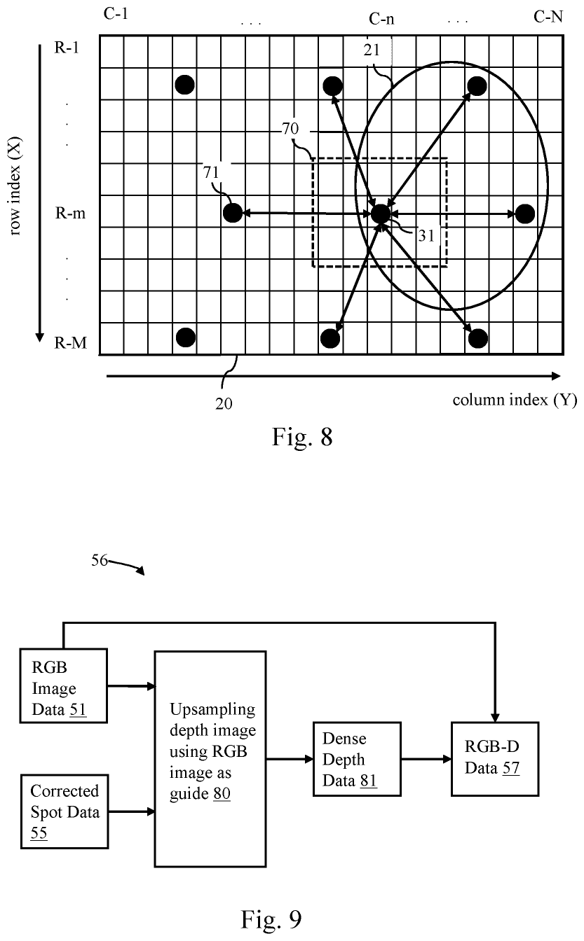

FIG. 6 schematically illustrates an embodiment of determining a spatial weight kernel, FIG. 7 schematically illustrates an embodiment of determining a guide image weight kernel and FIG. 8 schematically illustrates an embodiment of determining a depth weight kernel, which are discussed in the following.

Referring to FIG. 6, the image sensor 20 of FIG. 2 is schematically depicted there in which an edge 21 of foreground object is schematically depicted and in which the spots 31 are schematically depicted at their associated spot image pixel position.

The spot 31, for example, is determined as an edge spot, since it has an edge spot image pixel position which is one image pixel away from an edge image pixel position of the edge 21 and, thus, within a predetermined distance to the edge 21.

Around the edge spot 31 (edge spot image pixel position: X=R-m, Y=C-n), an image pixel position area 70 is defined.

For each image pixel position (i, j) within the image pixel position area 70, a weight is determined and the plurality of individual weights constitutes a weight kernel w_{(i,j)}.

The weight kernel w_{(i,j)} is based on a depth weight kernel w_{d}, a guide image kernel w_{g:(i,j)} and a spatial weight kernel w_{s:(i,j)}:

w_{(i,j)}=w_{s:(i,j)}·w_{g:(i,j)}·w_{d}, (9)

wherein the weight kernel is accumulated a plurality of times corresponding to a number of a plurality of adjacent spots used in the depth weight kernel.

The edge spot 31 should be moved to the image pixel position with the highest weight.

The spatial weight kernel w_{s:(i,j)} is given by:

$${w}_{s : ( i , j )} = exp ( - \frac{1}{2 {σ}_{s}^{2}} {‖ ( i , j ) - ( {x}_{n} , {y}_{n} ) ‖}^{2} ) , \qquad ( 10 )$$

wherein here (xₙ,yₙ) is the edge spot image pixel position of edge spot 31 and

$${σ}_{s}^{2}$$

is a parameter for controlling how easily the edge spot is moved by the spot misalignment filter 54.

The spatial weight kernel is highest at the original edge spot image pixel position, since it is put a trust in the original edge spot image pixel position.

Referring to FIG. 7, it is schematically illustrated there that the guide image weight kernel may be determined based on an RGB color value of an adjacent spot 72.

The guide image weight kernel w_{g:(i,j)} is given by:

$${w}_{g : ( i , j )} = \frac{{σ}_{g}^{2}}{{σ}_{g}^{2} + {‖ {I}_{i , j} - {I}_{{x}_{n} , {y}_{n}} ‖}^{2}} , \qquad ( 11 )$$

wherein here

$${σ}_{g}^{2}$$

is a scaling parameter and may be empirically determined or by simulation, Iₓ_{ₙ}_{,y}_{ₙ} is a color value of the adjacent spot 72, and I_{i,j} is a color value of the corresponding image pixel position within the image pixel position area 70.

The color value Iₓ_{ₙ}_{,y}_{ₙ} corresponds to a color value, for example, at the spot image pixel position of the adjacent spot 72 or from an image pixel position area (not shown) around the adjacent spot 72, which may have the same size as the image pixel position area 70 around the edge spot 31.

Thus, the guide image weight kernel is based on a similarity of color values in different, but adjacent parts of the image.

Referring to FIG. 8, it is schematically illustrated there that the depth weight kernel is determined based on a plurality of adjacent spots 71.

The depth weight kernel w_{d} is given by:

$${w}_{d} = \frac{{σ}_{d}^{2}}{{σ}_{d}^{2} + {‖ {D}_{{x}_{k} , {y}_{k}}^{S} - {D}_{{x}_{n} , {y}_{n}}^{S} ‖}^{2}} , \qquad ( 12 )$$

wherein here

$${σ}_{d}^{2}$$

is a scaling parameter and may be empirically determined or by simulation,

$${D}_{{x}_{n} , {y}_{n}}^{S}$$

is the depth value at the edge spot image pixel position, and

$${D}_{{x}_{k} , {y}_{k}}^{S}$$

is one of a plurality of depth values of a plurality of adjacent spots 71.

When the depth value difference gets larger, the weight is lowered and vice versa.

As mentioned above, the weight kernel is accumulated a plurality of times corresponding to a number of the plurality of adjacent spots 71 used in the depth weight kernel.

For example, if there are six adjacent spots 71, the weight accumulation process is performed six times.

A corresponding pseudo-code reads as follows:

```
for (k=0; k<6; k++) {
  weight_d = formula(12);
    for (i=0; i<I; i++) {
      for (j=0; j<J; j++) {
        weight_kernel[i][j] += weight_s[i][j] *
        weight_g[i][j] * weight_d;
    }
  }
},
```

wherein weight_s is the spatial weight kernel (formula (10)) and weight_g is the guide image weight kernel (formula (11)).

Generally, the depth weight kernel may have a large influence on the potential movement of the respective edge spot.

Thus, when the edge spot 31 is falsely associated with a foreground object, since it actually has a depth value of the background, the depth weight kernel pushes the edge spot 31 towards or on the background.

Moreover, for example, when the difference in depth values between the edge spot and the adjacent spots is small, the weight of the difference in color values may be accumulated more strongly, which may make it easier to move to the correct foreground object and background.

Accordingly, artefacts due to spot misalignment in AR (or MR or VR) applications may be reduced or prevented.

In this embodiment, the target spot may be moved to the position with the highest weight in the product of the spatial weight kernel and the guide image weight kernel, however, for spots where misalignment did not occur, the depth weight kernel with a maximum value in the middle tries to keep the edge spot in its original position, but for spots where misalignment occurred, the correction of misalignment may be achieved.

Returning to FIG. 5, once the weight kernel is determined, it is determined, at 61, whether there is different image pixel position with a maximum weight (correction score) above a preset threshold.

### If YES at 61:

The respective edge spot is moved, at 62, to a different spot ToF pixel position corresponding to the image pixel position with the highest weight (which is equivalent to moving it to a different associated image pixel position).

### If NO at 61:

It is determined, at 63, whether the correction score of the respective edge spot is below the preset threshold. Moreover, in some embodiments, it is checked additionally whether the number of adjacent spots used for determining the weight kernel is above a second preset threshold.

### If YES at 63:

The respective edge spot is removed at 64, since it is likely that it is a flying spot. When the edge spot has many adjacent spots and the correction score is small though, it may be likely that it is a flying spot. A flying spot may be a result of scattering and multiple reflections of the light on its way back from the object to the time-of-flight sensor.

### If NO at 63:

The spot ToF pixel position is kept.

Then, the corrected spot data is output at 55, as discussed above.

FIG. 9 schematically illustrates an embodiment of the RGB-D fusion 56 of FIG. 4, which is discussed in the following.

At 80, the RGB image data and the corrected spot data are input to an up-sampling routine, which associates the RGB image data with the corrected spot data and performs up-sampling of the corrected spot depth image over the entire RGB image using the RGB image as a guide such that dense depth data are output at 81.

At 57, the fused RGB-D data are obtained by associating the dense depth data with the RGB image data.

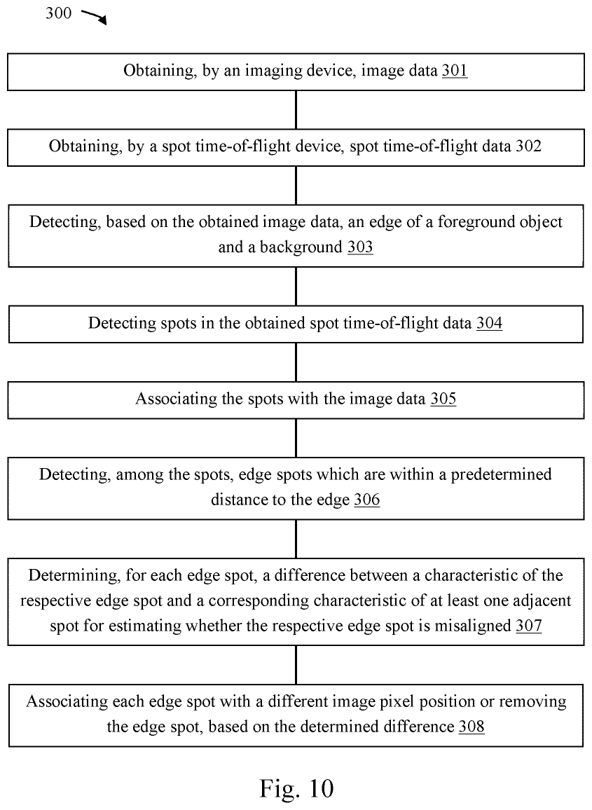

FIG. 10 schematically illustrates in a flow diagram an embodiment of an information processing method 300 for correcting spot misalignment, which is discussed in the following.

The information processing method may be performed by the information processing device as described herein, for example, by the information processing device 1 of FIG. 1.

At 301, image data is obtained by an imaging device, as discussed herein.

At 302, spot time-of-flight data is obtained by a spot time-of-flight device, as discussed herein.

At 303, an edge of a foreground object and a background is detected, based on the obtained image data, as discussed herein.

At 304, spots are detected in the obtained spot time-of-flight data, as discussed herein.

At 305, the spots are associated with the image data, as discussed herein.

At 306, edge spots, which are within a predetermined distance to the edge, are detected among the spots, as discussed herein.

At 307, for each edge spot, a difference between a characteristic of the respective edge spot and a corresponding characteristic of at least one adjacent spot is determined for estimating whether the respective edge spot is misaligned, as discussed herein.

At 308, each edge spot is associated with a different image pixel position or is removed, based on the determined difference, as discussed herein.

It should be recognized that the embodiments describe methods with an exemplary ordering of method steps. The specific ordering of method steps is however given for illustrative purposes only and should not be construed as binding.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Note that the present technology can also be configured as described below.
(1) An information processing device for correcting spot misalignment in a fusion of image data and spot time-of-flight data, including circuitry configured to:
   detect, based on obtained image data, an edge of a foreground object and a background;
   detect spots in obtained spot time-of-flight data;
   associate the spots with the image data;
   detect, among the spots, edge spots which are within a predetermined distance to the edge; and
   determine, for each edge spot, a difference between a characteristic of the respective edge spot and a corresponding characteristic of at least one adjacent spot for estimating whether the respective edge spot is misaligned.
(2) The information processing device of (1), wherein the characteristic is a depth value.
(3) The information processing device of (1) or (2), wherein the circuitry is further configured to associate an edge spot with a different image pixel position or to remove the edge spot, based on the determined difference.
(4) The information processing device of (2) or (3), wherein the circuitry is further configured to determine, based on the determined difference, a weight kernel for estimating whether the respective edge spot is misaligned.
(5) The information processing device of (4), wherein the weight kernel is further based on at least one of a guide image weight kernel and a spatial weight kernel.
(6) The information processing device of (4) or (5), wherein the circuitry is further configured to associate each edge spot with an image pixel position for which an associated weight of the weight kernel is maximal.
(7) The information processing device of anyone of (4) to (6), wherein the circuitry is further configured to remove an edge spot when the corresponding weight kernel is below a preset threshold.
(8) The information processing device of anyone of (1) to (7), including:
   an imaging device to obtain the image data; and
   a spot time-of-flight device to obtain the spot time-of-flight data.
(9) The information processing device of anyone of (1) to (8), wherein the image data are red-green-blue image data, and wherein the spot time-of-flight data are infrared spot time-of-flight data.
(10) The information processing device of anyone of (1) to (9), wherein the information processing device is a mobile terminal.
(11) An information processing method for correcting spot misalignment in a fusion of image data and spot time-of-flight data, including:
   detecting, based on obtained image data, an edge of a foreground object and a background;
   detecting spots in obtained spot time-of-flight data;
   associating the spots with the image data;
   detecting, among the spots, edge spots which are within a predetermined distance to the edge; and
   determining, for each edge spot, a difference between a characteristic of the respective edge spot and a corresponding characteristic of at least one adjacent spot for estimating whether the respective edge spot is misaligned.
(12) The information processing method of (11), wherein the characteristic is a depth value.
(13) The information processing method of (11) or (12), further including associating an edge spot with a different image pixel position or to remove the edge spot, based on the determined difference.
(14) The information processing method of (12) or (13), further including determining, based on the determined difference, a weight kernel for estimating whether the respective edge spot is misaligned.
(15) The information processing method of (14), wherein the weight kernel is further based on at least one of a guide image weight kernel and a spatial weight kernel.
(16) The information processing method of (14) or (15), further including associating each edge spot with an image pixel position for which an associated weight of the weight kernel is maximal.
(17) The information processing method of anyone of (14) to (16), further including removing an edge spot when the corresponding weight kernel is below a preset threshold.
(18) The information processing method of anyone of (11) to (17), further including: obtaining, by an imaging device, the image data; and obtaining, by a spot time-of-flight device, the spot time-of-flight data.
(19) The information processing method of anyone of (11) to (18), wherein the image data are red-green-blue image data, and wherein the spot time-of-flight data are infrared spot time-of-flight data.
(20) The information processing method of anyone of (11) to (19), wherein the information processing method is performed by a mobile terminal.
(21) A computer program comprising program code causing a computer to perform the method according to anyone of (11) to (20), when being carried out on a computer.
(22) A non-transitory computer-readable recording medium that stores therein a computer program product, which, when executed by a processor, causes the method according to anyone of (11) to (20) to be performed.

1. An information processing device for correcting spot misalignment in a fusion of image data and spot time-of-flight data, comprising circuitry configured to:
detect, based on obtained image data, an edge of a foreground object and a background;
detect spots in obtained spot time-of-flight data;
associate the spots with the image data;
detect, among the spots, edge spots which are within a predetermined distance to the edge; and
determine, for each edge spot, a difference between a characteristic of the respective edge spot and a corresponding characteristic of at least one adjacent spot for estimating whether the respective edge spot is misaligned.

2. The information processing device of claim 1, wherein the characteristic is a depth value.

3. The information processing device of claim 1, wherein the circuitry is further configured to associate an edge spot with a different image pixel position or to remove the edge spot, based on the determined difference.

4. The information processing device of claim 2, wherein the circuitry is further configured to determine, based on the determined difference, a weight kernel for estimating whether the respective edge spot is misaligned.

5. The information processing device of claim 4, wherein the weight kernel is further based on at least one of a guide image weight kernel and a spatial weight kernel.

6. The information processing device of claim 4, wherein the circuitry is further configured to associate each edge spot with an image pixel position for which an associated weight of the weight kernel is maximal.

7. The information processing device of claim 4, wherein the circuitry is further configured to remove an edge spot when the corresponding weight kernel is below a preset threshold.

8. The information processing device of claim 1, comprising:
an imaging device to obtain the image data; and
a spot time-of-flight device to obtain the spot time-of-flight data.

9. The information processing device of claim 1, wherein the image data are red-green-blue image data, and wherein the spot time-of-flight data are infrared spot time-of-flight data.

10. The information processing device of claim 1, wherein the information processing device is a mobile terminal.

11. An information processing method for correcting spot misalignment in a fusion of image data and spot time-of-flight data, comprising:
detecting, based on obtained image data, an edge of a foreground object and a background;
detecting spots in obtained spot time-of-flight data;
associating the spots with the image data;
detecting, among the spots, edge spots which are within a predetermined distance to the edge; and
determining, for each edge spot, a difference between a characteristic of the respective edge spot and a corresponding characteristic of at least one adjacent spot for estimating whether the respective edge spot is misaligned.

12. The information processing method of claim 11, wherein the characteristic is a depth value.

13. The information processing method of claim 11, further comprising associating an edge spot with a different image pixel position or to remove the edge spot, based on the determined difference.

14. The information processing method of claim 12, further comprising determining, based on the determined difference, a weight kernel for estimating whether the respective edge spot is misaligned.

15. The information processing method of claim 14, wherein the weight kernel is further based on at least one of a guide image weight kernel and a spatial weight kernel.

16. The information processing method of claim 14, further comprising associating each edge spot with an image pixel position for which an associated weight of the weight kernel is maximal.

17. The information processing method of claim 14, further comprising removing an edge spot when the corresponding weight kernel is below a preset threshold.

18. The information processing method of claim 11, further comprising:
obtaining, by an imaging device, the image data; and
obtaining, by a spot time-of-flight device, the spot time-of-flight data.

19. The information processing method of claim 11, wherein the image data are red-green-blue image data, and wherein the spot time-of-flight data are infrared spot time-of-flight data.

20. The information processing method of claim 11, wherein the information processing method is performed by a mobile terminal.
